(19) United States
(12) Patent Application Publication
(10) Pub. No.: US 2015/0116708 A1
(43) Pub. Date: Apr. 30, 2015

(54) APPARATUS FOR MEASURING PARTICLE SIZE DISTRIBUTION BY LIGHT SCATTERING

(71) Applicant: David Spriggs, Malvern (GB)

(72) Inventor: David Spriggs, Malvern (GB)

(21) Appl. No.: 14/345,089

(22) PCT Filed: Sep. 11, 2012
(86) PCT No.: PCT/GB2012/052230

§ 371 Date: Jan. 6, 2015

Related U.S. Application Data
(60) Provisional application No. 61/534,861, filed on Sep. 14, 2011.

(51) Int. Cl. G01N 15/02; G01N 21/49

(52) U.S. Cl. CPC G01N 15/0211; G01N 21/49; G01N 2201/06113
USPC 356/336

(57) ABSTRACT

Apparatus for determining particle-size distribution of a sample by light-scattering includes a helium neon laser (102), a sample cell having cell windows (120, 122) and a focal plane detector (124). Detectors are also provided for detecting light scattered by a sample within or flowing through the sample cell. The apparatus includes a first (114) and second (116) folding mirrors arranged to fold the optical path from the laser to the sample cell so that the laser is vertically below the sample cell. The folding mirrors are mounted within a dust-proof housing (104), the entrance (106) and exit (108) components thereof being other optical components generally used within light- scattering apparatus. The entrance component is mounted such that its outward normal points downwards and the exit component is mounted substantially vertically so that these components do not accumulate dust. The invention allows the laser of a light-scattering apparatus to be positioned vertically below a sample cell of the apparatus without the accumulation of dust on optical components, which tends to degrade performance.

The invention concerns apparatus for measuring particle-size distribution by light-scattering.

In an example of a known type of apparatus for measuring particle-size distribution by light-scattering, light from a light source, for example a laser, is directed along an optical path to a sample cell containing particles the size distribution of which is to be determined. Measurement of the distribution of scattered light in various directions with respect to the direction of light incident on the sample cell, together with measurement of the obscuration of the sample cell, allows particle-size distribution to be determined. The total length of the apparatus depends largely on the physical length of the optical path from the light source to the sample cell, and from the sample cell to a focal plane detector comprised in the apparatus and arranged to detect light transmitted by the sample. The total length of the apparatus can be significant. One option for reducing the total length of the apparatus is to fold the optical path between the light source and the sample cell. During use of such apparatus it is frequently necessary to flow particulate matter through the sample cell, and for reasons of practical convenience the flow direction is usually in the horizontal plane (when the apparatus is in its normal operating orientation), normal to the optical path through the sample cell.

The present invention provides apparatus for measuring the particle-size distribution of a sample by light scattering, the apparatus comprising a light source arranged to provide an output beam along an optical path to a sample cell or means for holding a sample cell, the optical path being folded at a first folding mirror having mirror normal in a direction which has a component in an upward direction when the apparatus is its normal operating orientation, and wherein the mirror is contained within a dust-proof housing having an optical entrance and exit optical components the outward normals of which are either substantially horizontal or have a component in a downward direction when the apparatus is in its normal operating orientation.

The invention provides apparatus in which the optical path between the light source and the sample cell is folded such that the light source and a portion of that optical path are vertically displaced from the sample cell when the apparatus is in its normal operating orientation. This allows a flow of particles to be provided through the sample cell by means of input and output conduits which lie in a generally horizontal plane when the apparatus is in use, without obstruction by the light source or the optical path. This type of arrangement is preferred in such apparatus because is allows a sample cell to be engaged or disengaged with the apparatus more easily. Since the optical path between the light source and the sample cell is folded such that the light source and a portion of that optical path are vertically displaced from the sample cell when the apparatus is in its normal operating orientation, the folding mirror has a mirror normal which has component in a generally upward direction when the apparatus is in its normal operating orientation. By containing the folding mirror within a dust-proof housing, dust does not accumulate over time on the folding mirror. Accumulated dust on optical components of the apparatus is undesirable because it causes unwanted light-scattering which degrades the signal-to-noise ratio for light scattered within the sample cell. The entrance and exit optical components of the dust-proof housing have outward normals which are either substantially horizontal or which have a component in a downward direction when the apparatus is in its normal operating orientation so that these components also do not accumulate dust over time. By enclosing the folding mirror in a dust-proof housing, other optical components remain easily accessible for maintenance, adjustment, servicing, replacement etc. This reduces the frequency with which apparatus needs to be returned to a servicing location for maintenance work compared to the case where the entire apparatus is enclosed in a dust-proof housing.

Although some light-scattering instruments of the prior art incorporate fibre-coupled light sources which allows size reduction, such instruments may not be well suited to analysing samples which include small particles because optical fibres may scramble the polarisation state of light output from a light source. Also, alignment of a light source to the input end of an optical fibre is difficult and optical coupling may be inefficient. This reduces the optical power available from the output end of the fibre, making light-scattering measurements on small particles more difficult. The present invention allows the realisation of a compact apparatus having a wide dynamic range, whilst allowing a horizontal flow of particles through the sample cell to be established without obstruction by a light source.

The optical path may be folded additionally at a second folding mirror which is mounted within the dust-proof housing. This provides for greater flexibility in the layout of the apparatus. It can also allow further reduction in the overall size of the apparatus—for example if the light source is a helium-neon laser, the laser may be positioned so that its resonator axis is substantially parallel to the portion of the optical path between the dust-proof housing and the sample cell. An optical baffle may be provided between the first and second folding mirrors in order to improve beam quality. For example extremities of a Gaussian beam from a HeNe laser which are reflected from the interior surface of the dust-proof housing may be blocked by use of a baffle. If unblocked, such reflections tend to result in a ring of light at the focal plane of the apparatus, disrupting measurements.

The portions of the optical path between the light source and the dust-proof housing and between the dust-proof housing and the sample cell (or the means for holding the sample cell) may for example lie in respective planes which are substantially horizontal when the apparatus is in its normal operating orientation. Said portions of the optical path may lie in a single vertical plane to further reduce the overall size of the apparatus.

Preferably the exit optical component of the dust-proof housing is a lens disposed substantially vertically when the apparatus is in its normal operating orientation, the lens being arranged to provide a converging beam to the sample cell or the means for holding a sample cell. This allows the lens to be incorporated into the dust-proof housing to provide a “reverse Fourier” type arrangement, whilst avoiding the need for a separate exit window and thus reducing optical losses within the apparatus. Preferably the lens is a symmetric triplet lens; such a lens has the advantage that two of its constituent elements are identical, allowing easier and cheaper fabrication. In order to make the apparatus less sensitive to misalignment resulting in coma aberration, preferably the apparatus is optically symmetric about the triplet lens.

It should be noted that although reference has been made above to “a sample cell or means for holding a sample cell” there may be simply a zone or region at which particles are presented for analysis within the converging beam. For example, in some cases a spray of particles may be passed through the converging beam, in which case there is no sample cell or means for holding a sample cell. Thus, “sample cell or means for holding a sample cell” should be interpreted to include this possibility.

The entrance optical component of the dust-proof housing may be a plane glass window having an outward normal having a component in a downward direction when the apparatus is in its normal operating orientation. This allows a portion (e.g. a few percent) of the output power of the light source to be directed away from the optical path for monitoring purposes. Such a component is frequently required in light-scattering apparatus: by incorporation of this element into the dust-proof housing the need for a separate entrance window is avoided, thus reducing optical losses in apparatus of the invention. More preferably the front or outer surface is uncoated and the rear surface (i.e. the surface within the dust-proof housing) is AR coated so that optical power is not lost by reflection at the rear surface. Apparatus of the invention may further comprise an optical detector arranged to receive light from the light source reflected by the plane glass window.

Preferably, the light source is a laser oscillator having a resonator axis coincident with the portion of the optical path between the laser oscillator and the dust-proof housing and wherein the apparatus comprises means for displacing the laser resonator along said portion of the optical path. This allows for the folding mirror, or folding mirrors, to be fixed in position in the dust-proof housing whilst simultaneously allowing the longitudinal position of the focus of light transmitted by the sample cell to be adjusted to coincide with a focal plane detector. Preferably the apparatus further comprises means for adjusting the output direction of the laser so that the transverse position of the focus can be adjusted, even though the folding mirror or mirrors are fixed in position within the dust-proof housing. Preferably the apparatus further comprises means for rotating the laser oscillator about the resonator axis so that the orientation of the electric field vector of the laser output about the optical path can be controlled where the laser output is linearly polarised. The laser may be a helium-neon laser for example.

Preferably the dust-proof housing is made of aluminium, the surfaces of the dust-proof housing having a hard anodised finish to allow easy cleaning. Cleaning can also be made more effective if the internal and/or external surfaces of the aluminium dust-proof housing have a low surface roughness.

Embodiments of the invention are described below with reference to the accompanying drawings in which:

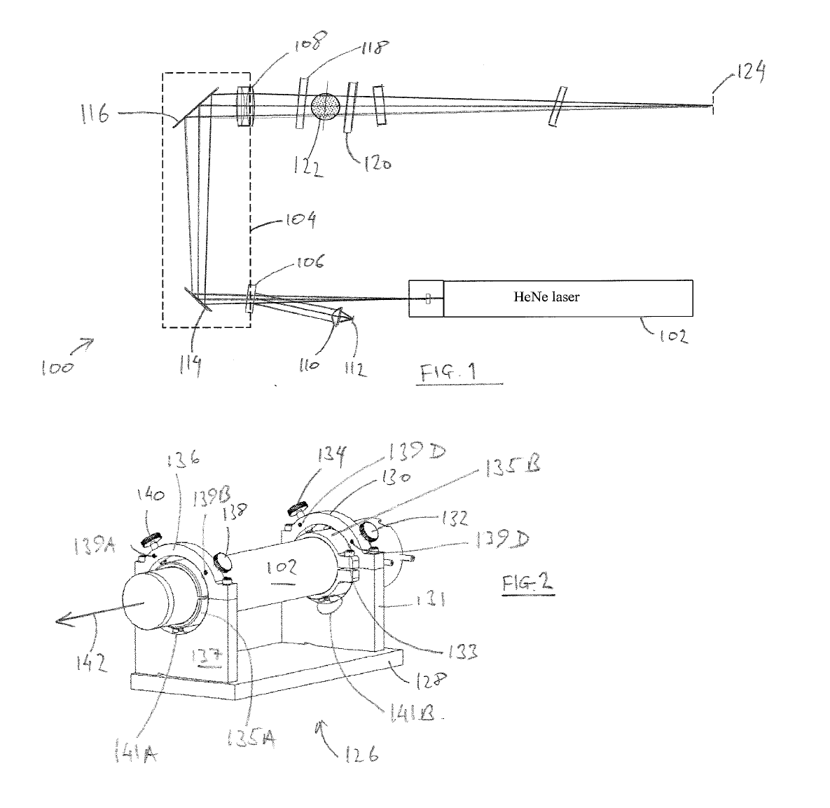

FIG. 1 shows a portion of an example light-scattering apparatus of the invention;

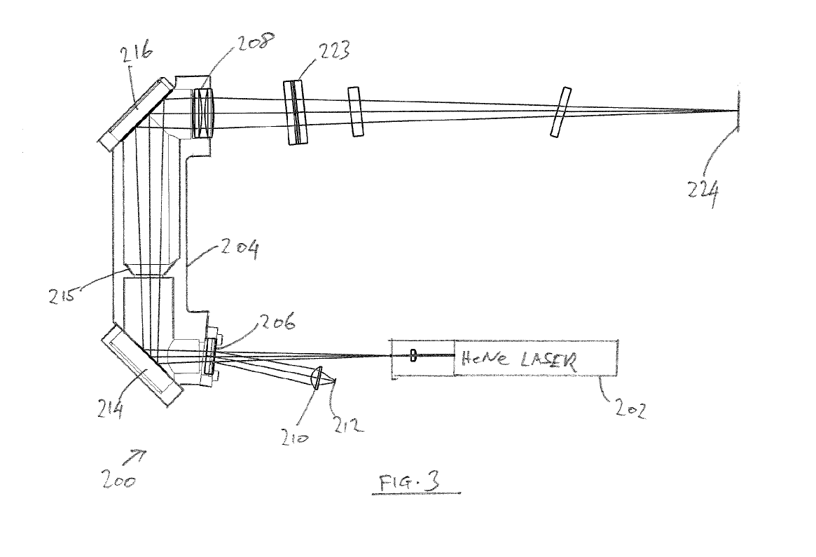

FIG. 2 shows an arrangement for mounting a laser comprised in the FIG. 1 apparatus;

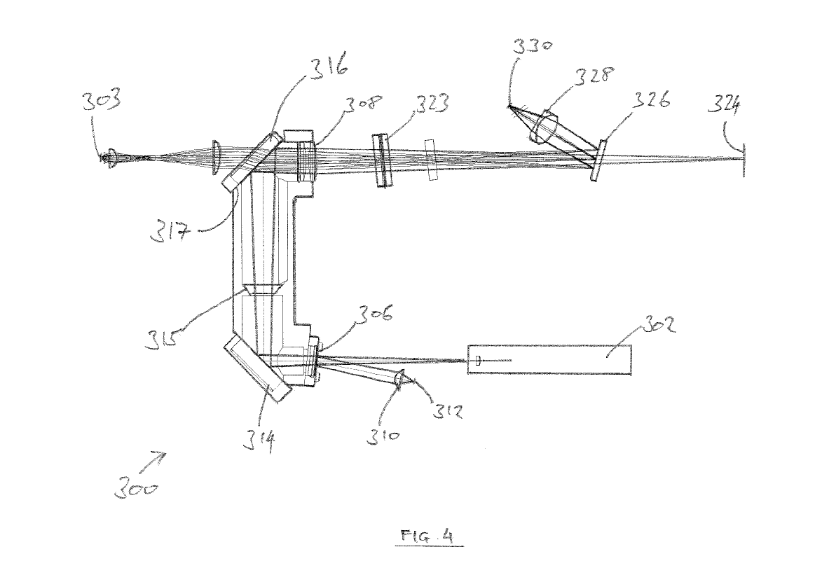

FIG. 3 shows a portion of a second example apparatus of the invention; and

FIG. 4 shows a portion of a third example apparatus of the invention.

Referring to FIG. 1, a portion of an example light-scattering apparatus of the invention is indicated generally by 100. The apparatus comprises a helium-neon laser 102, a detector 112 and associated lens 110, first 114 and second 116 folding mirrors mounted within a dust-proof housing 104 having entrance 106 and exit 108 optical components, a sample cell having cell windows 118, 120, and a focal plane detector 124. The entrance optical component 106 of the dust-proof housing 104 is a plane glass window 106 having an uncoated front (outer) surface and an AR-coated rear (inner surface). The exit optical component 108 is a symmetric triplet lens. The optical path followed by light from the laser 102 to the sample cell and transmitted to the focal plane detector 124 is in a single vertical plane (the plane of FIG. 1). The outward normal of the window 106 is in a direction having a component in a vertically downward direction so that the window 106 does not accumulate dust on its exterior surface over time. The lens 108 is mounted in the dust-proof housing 104 substantially vertically so that it also does not gather dust over time. (In other words the normal to the surface of the lens which forms an external surface of the dust-proof housing 104 is substantially horizontal when the apparatus is in its normal operating orientation.)

In use of the apparatus, a flow of particulate matter is established through the sample cell in region 122 between the cell windows 118, 120. The direction of flow through the sample cell is substantially horizontal (i.e. perpendicular to the plane of FIG. 1). Light output by the laser 102 passes through the plane glass window 106. A few percent of the optical power from the laser 102 is reflected to lens 110 and focussed onto the detector 112 to provide monitoring of the output power of the laser 102. The remainder of the output power of the laser 102 passes to a first plane folding mirror 114 and a second plane folding mirror 116 before exiting the dust-proof housing 104 via the exit component 108 which is a symmetric triplet lens arranged to provide a converging beam of light to the sample cell. (The apparatus is thus a “reverse-Fourier” type arrangement.) Light transmitted (i.e. not scattered) by the sample cell is focussed at the focal plane detector 124. The apparatus comprises other detectors (not shown) arranged to detect light scattered by a sample in the sample cell. In order to reduce the sensitivity of the apparatus to coma aberration resulting from any misalignment of optical components, the optical path from the laser 102 to the focal plane detector 124 is substantially symmetrical.

The plane folding mirrors 114, 116 are fixed in position within the dust-proof housing, as are the components 106, 108. In order to allow the position of the focus of light transmitted by the sample cell to be adjusted so that it is coincident with the focal plane detector 124, the laser 102 is mounted in an adjustable mount 126 as indicated in FIG. 2. The mount 126 comprises collars 135A, 135B which hold respective ends of the laser 102. The collars may be tightened or loosened by mean of screws, e.g. 133. When the collars 135A, 135B are loosened, the laser 102 may be moved along the output direction 142 of the laser or in the opposite direction, thus adjusting the longitudinal position of the focus in the vicinity of the focal plane detector 124. Also, the laser 102 may be rotated about its longitudinal axis to adjust the orientation of the polarisation of the laser output. The collars 135A, 135B are supported within upright portions 137, 131 of the mount 126 and clamp portions 136, 130 attached thereto.

Collar 135A is held in position by two ball-ended adjustment screws 138, 140 and a spring-loaded, ball-ended pin 141A. The adjustment screws 138, 140 and pin 141A are arranged azimuthally around the longitudinal axis of the laser 102 at intervals of 120°. Similarly, collar 135B is held in position by ball-ended adjustment screws 132, 134 and a spring-loaded ball-ended pin 141B. The ball-ended adjustment screws 132, 134, 138, 140 each have an associated locking grub screw 139D-A allowing them to be locked in position and released for adjustment. Adjacent to each of the pins 141A, 141B is a ball-ended locking screw (not shown) which can be advanced upwardly to clamp the collars 135A, 135B from below. Access to these screws is via a recess in the base portion 128. To adjust the transverse position of the front (output end) of the laser 102, the grubs screws 138, 140 and the ball-ended locking screw adjacent the pin 141A are loosened and the ball-ended adjustment screws 138, 140 are adjusted as required. To fix the transverse position of the front end of the laser 102 the locking grub screws 139A, 139B and the ball-ended locking screw adjacent pin 141A are tightened up. The transverse position of the rear end of the laser 102 may be adjusted similarly.

The mount 126 provides a low-cost, large-range, low stress and easy-to-use adjustment device providing six degrees of freedom for the laser 102 (transverse movement in two orthogonal directions at each end of the laser 102, plus longitudinal movement and rotation.) The focal plane detector 124 is mounted on an xy stage (not shown in FIG. 1) which allows high-precision transverse alignment of the detector 124. The apparatus therefore provides both coarse and fine adjustments to allow the focus of light transmitted by the sample cell to be aligned with the focal plane detector 124.

Referring to FIG. 3, a portion of a second example apparatus of the invention is indicated generally by 200. Parts of the apparatus of FIG. 3 which correspond to parts of the apparatus of FIG. 1 are labelled using reference signs which differ by 100 from those labelling the corresponding parts in FIG. 1. The apparatus comprises first 214 and second 216 folding mirrors, an entrance window 206 and a symmetric triplet lens 208 mounted in a sealed unit 204 of aluminium construction with a hard anodised finish to reduce flaking or shedding of particles from its surface. The folding mirrors 214, 216 are front face mounted directly against accurately machined flats of the unit 204 to provide a barrier against dust and to maintain accurate angle tolerances. About one third of the way between the first folding plane mirror 214 and the second folding plane mirror 216 is a baffle 215 which blocks stray light originating from the extreme wings of the Gaussian beam from the laser 102 and reflecting from interior surface of the unit 204.

FIG. 4 shows a portion 300 of a third example apparatus of the invention. The apparatus is similar to that of FIG. 3. Parts shown in FIG. 4 which correspond to parts in FIG. 3 are labelled with reference signs which differ by 100 from those labelling the corresponding parts in FIG. 3. As is the case with FIG. 3, the apparatus of which the portion 300 is part comprises detectors arranged to detect light scattered by a sample in the sample cell 323 when the apparatus is in use. The apparatus may further include computation means for computing particle-size distribution using output signals from these detectors and the focal plane detector 324. Alternatively the apparatus may include data storage means so that computation of particle-size distribution may be performed subsequently to operation of the apparatus.

The apparatus of FIG. 4 includes a second light source 303, which is a blue LED, in addition to HeNe laser 302. The front face 317 of the second folding mirror 316 has a dichroic coating so that, in use of the apparatus, blue light from LED 303 is passed through the second folding mirror 316 and then passes through the converging lens 308 to the sample cell 323. The apparatus includes a component 326 arranged to reflect blue light transmitted by the sample cell to a detector 330 via a collection lens 328. Red light originating from the He Ne laser passes through the component 326 and is detected by focal plane detector 324. By providing for scattering measurements to be made at two wavelengths the apparatus allows particle-size distribution to be determined for a wider range of particles sizes than is the case if only a single wavelength is used.

1. Apparatus for measuring the particle-size distribution of a sample by light scattering, the apparatus comprising a light source arranged to provide an output beam along an optical path to a sample cell, or means for holding a sample cell, the optical path being folded at a first folding mirror having mirror normal in a direction which has a component in an upward direction when the apparatus is its normal operating orientation, and wherein the first folding mirror is contained within a dust-proof housing having an optical entrance and exit optical components the outward normals of which are either substantially horizontal or have a component in a downward direction when the apparatus is in its normal operating orientation.

2. Apparatus according to claim 1, wherein the light source is mounted in an adjustable mount, the adjustable mount being configured to allow adjustment of at least one of:
a position of focus of the optical path;
the position of the light source, in a direction parallel to the output beam;
the orientation of the light source, by rotating the light source about the axis of the output beam;
the direction of the output beam;
the position of an output end of the light source, in a direction transverse to the output beam;
the position of a rear end of the light source, the rear end being opposite to the output end, in a direction transverse to the output beam.

3. Apparatus according to claim 2, wherein the adjustable mount comprises collars which hold respective ends of the light source.

4. Apparatus according to claim 2 or 3, wherein the output end of the light source is supported by two adjustment screws and a spring loaded pin, arranged azimuthally around the light source, and/or the rear end of the light source is supported by two adjustment screws and a spring loaded pin, arranged azimuthally around the light source; and
the transverse position of the output end and/or rear end is adjustable by adjusting the respective adjustment screws,

5. Apparatus according to any of claims 1 wherein the optical path is folded additionally at a second folding mirror mounted within the dust-proof housing.

6. Apparatus according to claim 5 further comprising a baffle, or optical aperture, disposed between the first and second folding mirrors.

7. Apparatus according to claim 5 wherein the portions of the optical path between the light source and the dust-proof housing and between the dust-proof housing and the sample cell or the means for holding the sample cell lie in respective planes which are substantially horizontal when the apparatus is in its normal operating orientation.

8. Apparatus according claim 7 wherein said portions of the optical path lie in a single vertical plane.

9. Apparatus according to claim 7 wherein the exit optical component is a lens disposed substantially vertically when the apparatus is in its normal operating orientation, the lens being arranged to provide a converging beam to the sample cell or the means for holding a sample cell.

10. Apparatus according to claim 9 wherein the lens has a symmetric triplet form.

11. Apparatus according to claim 10 wherein the apparatus is substantially optically symmetric about the symmetric triplet lens.

12. Apparatus according to claim 1 wherein the entrance optical component of the dust-proof housing is a plane glass window the outward normal of which has a component in a downward direction when the apparatus is in its normal operating orientation, and wherein the external surface of the window is uncoated.

13. Apparatus according to claim 12 wherein the internal surface of the window is AR coated.

14. Apparatus according to claim 12 further comprising a detector arranged to receive light from the light source reflected by the uncoated plane glass window.

15. Apparatus according to claim 1 wherein the light source is a laser oscillator having a resonator axis coincident with the portion of the optical path between the laser oscillator and the dust-proof housing.

16. Apparatus according to claim 15 wherein the laser oscillator is a helium-neon laser oscillator.

17. Apparatus according to claim 1 wherein the dust-proof housing is made of aluminium and the surfaces of the dust-proof housing have a hard anodised finish.

18. Apparatus according to claim 17 wherein at least one of the internal surface of the dust-proof housing and the external surface thereof has a low surface roughness.
